(19) United States
(12) Patent Application Publication
(10) Pub. No.: US 2021/0183392 A1
(43) Pub. Date: Jun. 17, 2021

(54) PHONEME-BASED NATURAL LANGUAGE PROCESSING

(71) Applicant: LG ELECTRONICS INC., Seoul (KR)

(72) Inventors: Kwangyong LEE, Seoul (KR); Hyunseob LEE, Seoul (KR)

(73) Assignee: LG ELECTRONICS INC., Seoul (KR)

(21) Appl. No.: 17/028,361

(22) Filed: Sep. 22, 2020

(30) Foreign Application Priority Data
Dec. 12, 2019 (KR) 10-2019-0165523

(51) Int. Cl. G10L 15/26; G10L 15/197; G10L 15/02; G10L 15/16

(52) U.S. Cl. CPC G10L 15/26; G10L 15/197; G10L 2015/025; G10L 15/16; G10L 15/02

(57) ABSTRACT

A natural language processing method and apparatus are disclosed. A natural language processing method according to an embodiment of the present disclosure includes extracting a phoneme string from a text corpus labeled with recognition information including at least one of one named entity (NE) or speech intention, generating a phoneme-based training data set by labeling the recognition information in the extracted phoneme string, and generating an artificial neural network-based learning model (LM) using the generated training data set. The natural language processing method of the present disclosure may be associated with an artificial intelligence module, a drone (Unmanned Aerial Vehicle, UAV), a robot, an AR (Augmented Reality) device, a VR (Virtual Reality) device, a device associated with 5G services, etc.

### CROSS-REFERENCE TO RELATED APPLICATION

This application claims the benefit of Korean Patent Application No. 10-2019-0165523 filed on Dec. 12, 2019, the entire disclosure of which are hereby incorporated by reference herein for all purposes.

### BACKGROUND OF THE INVENTION

### Field of the Invention

The present disclosure relates to phoneme-based natural language processing method and apparatus.

### Description of the Related Art

Artificial intelligence technologies are composed of machine learning (deep learning) and element technologies utilizing the machine learning.

The machine learning is an algorithm technology that classifies/learns features of input data by itself. The element technology is a technology that simulates functions such as cognition and judgment of the human brain by utilizing machine learning algorithms such as the deep learning, and is composed of technical fields such as linguistic understanding, visual understanding, inference/prediction, knowledge expression, and motion control.

On the other hand, there is a problem in that the performance of speech recognition is deteriorated due to various named entities (NE) input in different languages and/or accents, and it is necessary to process efficiently the named entities that vary due to diversity of languages and/or accents.

### SUMMARY OF THE INVENTION

The present disclosure is intended to solve address the above-described needs and/or problems.

In addition, an object of the present disclosure is to implement phoneme-based natural language processing method and apparatus capable of recognizing a named entity from a text or a voice input in various languages.

In addition, an object of the present disclosure is to implement phoneme-based natural language processing method and apparatus capable of efficiently performing NLP in response to an input of a voice or a text that is changed due to diversity of languages or diversity of accents.

A natural language processing (NLP) method according to an aspect of the present disclosure includes extracting a first phoneme string corresponding to one named entity (NE) from a grapheme-based text corpus including texts of different accents or languages for the one NE; generating a phoneme-based training data set by labeling at least one of the NE or speech intention in the first phoneme string; and generating an artificial neural network-based learning model (LM) using the phoneme-based training data set.

In addition, the text corpus may include at least two languages.

In addition, the text corpus may include at least one dialect.

In addition, the extracting the first phoneme string may include generating an output by extracting a first feature from the text corpus, and applying the first feature to a first model for generating a phoneme; and generating a phoneme corresponding to each syllable included in the text corpus based on the output.

In addition, when the texts of different accents or languages for the one NE exist among texts included in the text corpus, the first model may be an artificial neural network-based LM trained to generate an output representing the same phoneme string when the texts of different accents or languages are applied to the first model.

In addition, the generating the phoneme-based training data set may include generating an output by extracting a second feature from the first phoneme string, and applying the second feature to a second model for labeling at least one of the NE or the speech intention; and tagging at least one of the NE or the speech intention in the first phoneme string based on the output.

In addition, the artificial neural network may include an input layer, an output layer, and at least one hidden layer, and the input layer, the output layer, and the at least one hidden layer may include at least one node.

In addition, some of the at least one node may have different weights to generate a targeted output.

In addition, the artificial neural network may be an artificial neural network based on any one of a convolutional neural network or a recurrent neural network.

In addition, the method may further include receiving a speech voice; transcribing a text from the received speech voice; extracting a second phoneme string from the transcribed text, and extracting a third feature from the second phoneme string; and generating an output for determining the NE or the speech intention by applying the third feature to the LM.

In addition, the method may further include generating a response including the NE or the speech intention based on the output.

In addition, the LM may include an acoustic model for predicting a confidence score of the NE or a language model for predicting the speech intention.

A natural language processing apparatus according to another aspect of the present disclosure includes a memory configured to store a grapheme-based text corpus including texts of different accents or languages for one named entity (NE); and a processor configured to extract a first phoneme string corresponding to the one NE from the grapheme-based text corpus, generate a phoneme-based training data set by labeling at least one of the NE or speech intention in the first phoneme string, and generate an artificial neural network-based learning model (LM) using the phoneme-based training data set.

Effects of the phoneme-based natural language processing method and apparatus according to an embodiment of the present disclosure will be described as follows.

The present disclosure can recognize the named entity (NE) from the text or voice input in various languages.

In addition, the present disclosure can efficiently perform NLP in response to the input of the voice or text that is changed due to diversity of languages or diversity of accents.

The effects obtained in the present disclosure are not limited to the above-mentioned effects, and other effects not mentioned will be clearly understood by those skilled in the art from the following description.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an user equipment and a 5G network in a 5G communication system.

FIG. 4 is a block diagram of an electronic device.

FIG. 5 illustrates a schematic block diagram of an AI server according to an embodiment of the present disclosure.

FIG. 6 illustrates a schematic block diagram of an AI device according to another embodiment of the present disclosure.

FIG. 7 is a conceptual diagram illustrating an embodiment of an AI device.

FIG. 8 illustrates an exemplary block diagram of a speech processing apparatus in a speech processing system according to an embodiment of the present disclosure.

FIG. 9 illustrates an exemplary block diagram of a speech processing apparatus in a speech processing system according to another embodiment of the present disclosure.

FIG. 10 illustrates an exemplary block diagram of an artificial intelligent agent according to an embodiment of the present disclosure.

FIG. 11 is a view for explaining a speech recognition method by a conventional speech.

FIG. 12 is a schematic flowchart of a method for generating a phoneme-based learning model according to some embodiments of the present disclosure.

FIG. 13 is a schematic flowchart of an inference process using a learned phoneme-based learning model.

FIG. 14 is a view showing an example of implementation of a natural language processing method according to an embodiment of the present disclosure.

FIG. 15 is an exemplary diagram of a G2P model applied to an embodiment of the present disclosure.

FIG. 16 is an example of implementation of a method for generating a phoneme-based learning model according to an embodiment of the present s disclosure.

FIG. 17 is an example of implementation of a natural language processing method using a phoneme-based learning model according to an embodiment of the present disclosure.

### DETAILED DESCRIPTION OF THE EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

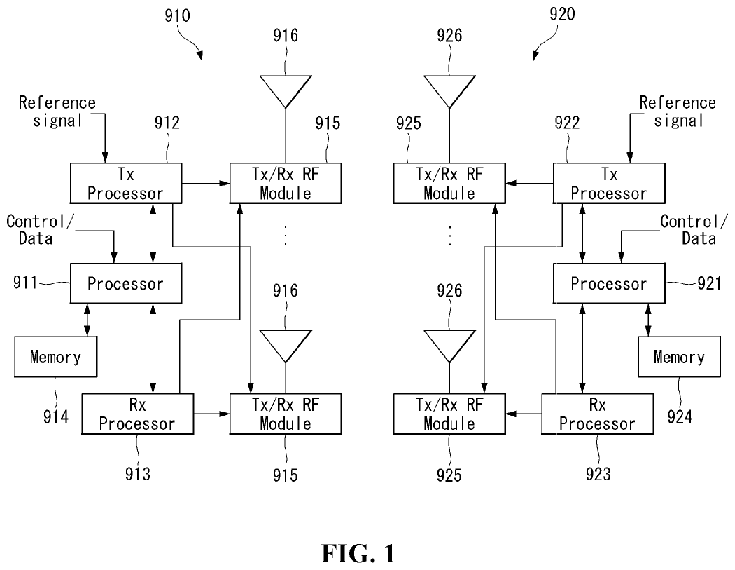

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

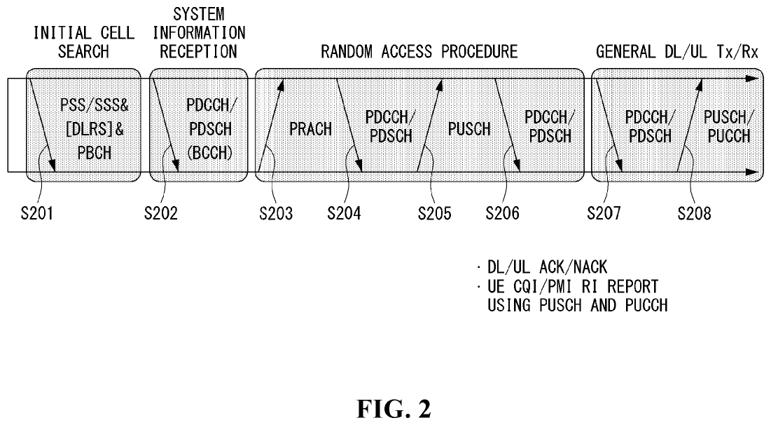

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

[symbol]

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

[symbol]

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

[symbol]

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

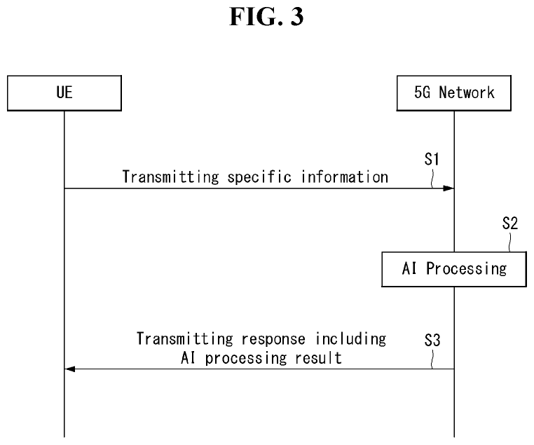

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

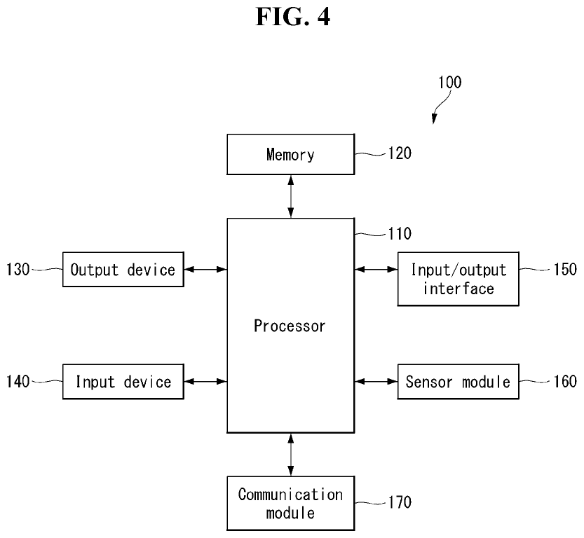

FIG. 4 is a block diagram of an electronic device.

Referring to FIG. 4, the electronic device 100 may include at least one processor 110, a memory 120, an output device 130, an input device 140, an input/output interface 150, a sensor module 160, and a communication module 170.

The processor 110 may include at least one application processor (AP), at least one communication processor (CP), or at least one artificial intelligence (AI) processor. The application processor, the communication processor, or the AI processor may be included in different integrated circuit (IC) packages, respectively, or may be included in one IC package.

The application processor may control a plurality of hardware or software components connected to the application processor by driving an operating system or an application program, and perform various data processing/operation including multimedia. As an example, the application processor may be implemented as a system on chip (SoC). The processor 110 may further include a graphic processing unit (GPU) (not shown).

The communication processor may perform functions of managing a data link and converting a communication protocol in communication between the electronic device 100 and other electronic devices connected through a network. As an example, the communication processor may be implemented as the SoC. The communication processor may perform at least some of a multimedia control function.

In addition, the communication processor may control data transmission and reception of the communication module 170. The communication processor may be implemented to be included as at least a part of the application processor.

The application processor or the communication processor may load and process a command or data received from at least one of a non-volatile memory or other components connected to each into a volatile memory. In addition, the application processor or the communication processor may store data received from at least one of other components or generated by at least one of the other components in the non-volatile memory.

The memory 120 may include an internal memory or an external memory. The internal memory may include at least one of a volatile memory (e.g. dynamic RAM (DRAM)), static RAM (SRAM), synchronous dynamic RAM (SDRAM)) or a non-volatile memory (e.g. one time programmable ROM (OTPROM)), programmable ROM (PROM), erasable and programmable ROM (EPROM), electrically erasable and programmable ROM (EEPROM), mask ROM, flash ROM, NAND flash memory, NOR flash memory, etc.). According to an embodiment, the internal memory may take the form of a solid state drive (SSD). The external memory may further include flash drive, for example, compact flash (CF), secure digital (SD), micro secure digital (Micro-SD), mini secure digital (Mini-SD), extreme digital (xD) or a memory stick, etc.

The output device 130 may include at least one of a display module or a speaker. The output device 130 may display various data including multimedia data, text data, voice data, or the like to a user or output the sound.

The input device 140 may include a touch panel, a digital pen sensor, a key, or an ultrasonic input device, etc. As an example, the input device 140 may be the input/output interface 150. The touch panel may recognize a touch input in at least one of capacitive, pressure-sensitive, infrared, or ultrasonic types. In addition, the touch panel may further include a controller (not shown). In the case of the capacitive type, not only direct touch but also proximity recognition is possible. The touch panel may further include a tactile layer. In this case, the touch panel may provide a tactile reaction to the user.

The digital pen sensor may be implemented using the same or similar method to receiving a user's touch input or a separate recognition layer. The key may be a keypad or a touch key. The ultrasonic input device is a device that can confirm data by detecting a micro-sonic wave at a terminal through a pen generating an ultrasonic signal, and is capable of wireless recognition. The electronic device 100 may also receive a user input from an external device (for example, a network, computer, or server) connected thereto using the communication module 170.

The input device 140 may further include a camera module and a microphone. The camera module is a device capable of photographing images and videos, and may include one or more image sensors, an image signal processor (ISP), or a flash LED. The microphone may receive a voice signal and convert it into an electrical signal.

The input/output interface 150 may transmit commands or data input from the user through the input device or the output device to the processor 110, the memory 120, the communication module 170, and the like through a bus (not shown). For example, the input/output interface 150 may provide data for a user's touch input input through the touch panel to the processor 110. For example, the input/output interface 150 may output a command or data received from the processor 110, the memory 120, the communication module 170, etc. through the bus through the output device 130. For example, the input/output interface 150 may output voice data processed through the processor 110 to the user through the speaker.

The sensor module 160 may include at least one of a gesture sensor, a gyro sensor, a barometric pressure sensor, a magnetic sensor, an acceleration sensor, a grip sensor, a proximity sensor, an RGB (red, green, blue) sensor, a biometric sensor, a temperature/humidity sensor, an illuminance sensor or an ultra violet (UV) sensor. The sensor module 160 may measure physical quantities or sense an operating state of the electronic device 100 to convert the measured or sensed information into electrical signals. Additionally or alternatively, the sensor module 160 may include an E-nose sensor, an electromyography (EMG) sensor, an electroencephalogram (EEG) sensor (not shown), an electrocardiogram (ECG) sensor, a photoplethysmography (PPG) sensor, a heart rate monitor (HRM) sensor, a perspiration sensor, a fingerprint sensor, or the like. The sensor module 160 may further include a control circuit for controlling at least one sensor included therein.

The communication module 170 may include a wireless communication module or an RF module. The wireless communication module may include, for example, Wi-Fi, BT, GPS or NFC. For example, the wireless communication module may provide a wireless communication function using a radio frequency. Additionally or alternatively, the wireless communication module may include a network interface, modem, or the like for connecting the electronic device 100 to a network (e.g. Internet, LAN, WAN, telecommunication network, cellular network, satellite network, POTS or 5G network, etc.).

The RF module may be responsible for transmitting and receiving data, for example, transmitting and receiving an RF signal or a called electronic signal. As an example, the RF module may include a transceiver, a power amp module (PAM), a frequency filter, or a low noise amplifier (LNA), etc. In addition, the RF module may further include components for transmitting and receiving electromagnetic waves in a free space in wireless communication, for example, conductors or lead wires, etc.

The electronic device 100 according to various embodiments of the present disclosure may include at least one of a server, a TV, a refrigerator, an oven, a clothing styler, a robot cleaner, a drone, an air conditioner, an air cleaner, a PC, a speaker, a home CCTV, an electric light, a washing machine, and a smart plug. Since the components of the electronic device 100 described in FIG. 4 are exemplified as components generally provided in the electronic device, the electronic device 100 according to the embodiment of the present disclosure is not limited to the above-described components and may be omitted and/or added as necessary.

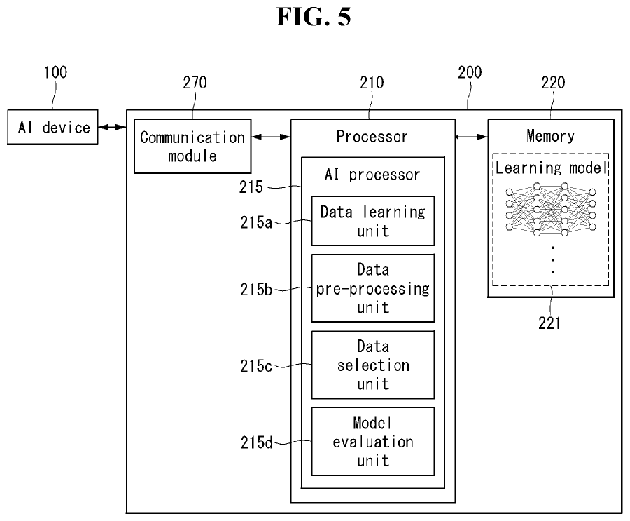

The electronic device 100 may perform an artificial intelligence-based control operation by receiving the AI processing result from a cloud environment shown in FIG. 5, or may perform AI processing in an on-device manner by having an AI module in which components related to the AI process are integrated into one module.

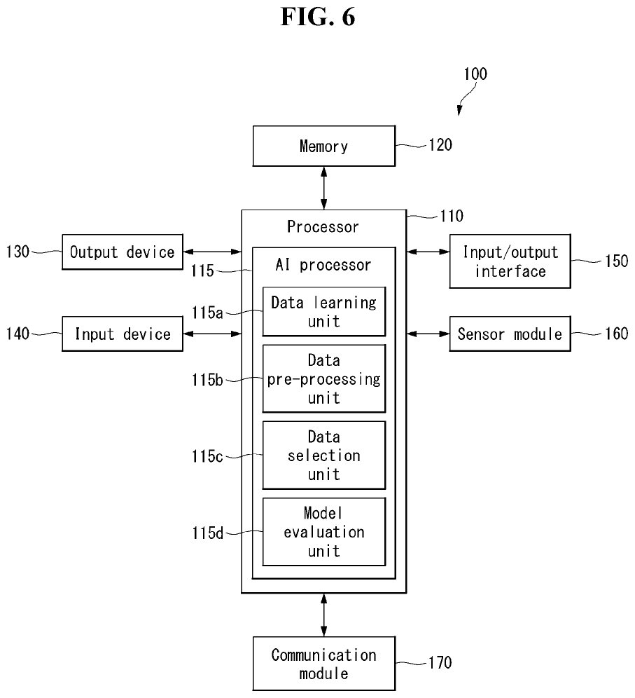

Hereinafter, an AI process performed in a device environment and/or a cloud environment or a server environment will be described with reference to FIGS. 5 and 6. FIG. 5 illustrates an example in which receiving data or signals may be performed in the electronic device 100, but AI processing for processing the input data or signals is performed in the cloud environment. In contrast, FIG. 6 illustrates an example of on-device processing in which the overall operation of AI processing on input data or signals is performed within the electronic device 100.

In FIGS. 5 and 6, the device environment may be referred to as a ‘client device’ or an ‘AI device’, and the cloud environment may be referred to as a ‘server’.

FIG. 5 illustrates a schematic block diagram of an AI server according to an embodiment of the present disclosure.

A server 200 may include a processor 210, a memory 220, and a communication module 270.

An AI processor 215 may learn a neural network using a program stored in the memory 220. In particular, the AI processor 215 may learn the neural network for recognizing data related to the operation of the AI device 100. Here, the neural network may be designed to simulate the human brain structure (e.g. the neuronal structure of the human neural network) on a computer. The neural network may include an input layer, an output layer, and at least one hidden layer. Each layer may include at least one neuron with weights, and the neural network may include a synapse connecting neurons and neurons. In the neural network, each neuron may output an input signal input through the synapse as a function value of an activation function for weight and/or bias.

A plurality of network modes may transmit and receive data according to each connection relationship so that neurons simulate synaptic activity of neurons that transmit and receive signals through the synapses. Here, the neural network may include a deep learning model developed from a neural network model. In the deep learning model, a plurality of network nodes are located on different layers and may exchange data according to a convolution connection relationship. Examples of the neural network model may include various deep learning techniques such as a deep neural network (DNN), a convolutional neural network (CNN), a recurrent neural network, a restricted Boltzmann machine, a deep belief network, and a deep Q-Network, and may be applied in fields such as vision recognition, voice recognition, natural language processing, and voice/signal processing.

On the other hand, the processor 210 performing the functions as described above may be a general-purpose processor (for example, a CPU), but may be a dedicated AI processor (for example, a GPU) for AI learning.

The memory 220 may store various programs and data necessary for the operation of the AI device 100 and/or the server 200. The memory 220 may be accessed by the AI processor 215, and read/write/modify/delete/update data by the AI processor 215. In addition, the memory 220 may store a neural network model (e.g. the deep learning model) generated through a learning algorithm for data classification/recognition according to an embodiment of the present disclosure. Furthermore, the memory 220 may store not only a learning model 221 but also input data, training data, and learning history, etc.

On the other hand, the AI processor 215 may include a data learning unit 215a for learning a neural network for data classification/recognition. The data learning unit 215a may learn criteria regarding what training data to use to determine data classification/recognition, and how to classify and recognize the data using the training data. The data learning unit 215a may learn the deep learning model by acquiring training data to be used for learning and applying the acquired training data to the deep learning model.

The data learning unit 215a may be manufactured in a form of at least one hardware chip and may be mounted on the server 200. For example, the data learning unit 215a may be manufactured in a form of a dedicated hardware chip for artificial intelligence, or may be manufactured as part of a general-purpose processor (CPU) or a dedicated graphics processor (GPU) and mounted on the server 200. In addition, the data learning unit 215a may be implemented as a software module. When implemented as the software module (or a program module including instructions), the software module may be stored in a computer-readable non-transitory computer readable media. In this case, at least one software module may be provided to an operating system (OS), or may be provided by an application.

The data learning unit 215a may learn the neural network model to have criteria for determining how to classify/recognize predetermined data using the acquired training data. At this time, a learning method by a model learning unit may be classified into supervised learning, unsupervised learning, and reinforcement learning. Here, the supervised learning may refer to a method of learning an artificial neural network in a state where a label for training data is given, and the label may mean a correct answer (or a result value) that the artificial neural network must infer when the training data is input to the artificial neural network. The unsupervised learning may mean a method of learning an artificial neural network in a state where the label for training data is not given. The reinforcement learning may mean a method in which an agent defined in a specific environment is learned to select an action or a sequence of actions that maximize cumulative rewards in each state. In addition, the model learning unit may learn the neural network model using a learning algorithm including an error backpropagation method or a gradient decent method. When the neural network model is learned, the learned neural network model may be referred to as the learning model 221. The learning model 221 is stored in the memory 220 and may be used to infer a result for new input data rather than the training data.

On the other hand, the AI processor 215 further include a data pre-processing unit 215b and/or a data selection unit 215c to improve analysis results using the learning model 221, or to save resources or time required to generate the learning model 221.

The data pre-processing unit 215b may pre-process the acquired data so that the acquired data may be used for learning/inference for situation determination. For example, the data pre-processing unit 215b may extract feature information as pre-processing for input data acquired through the input device, and the feature information may be extracted in a format such as a feature vector, a feature point, or a feature map.

The data selection unit 215c may select data necessary for learning among training data or training data pre-processed by the pre-processing unit. The selected training data may be provided to the model learn unit. For example, the data selection unit 215c may select only data for an object included in a specific region as training data by detecting a specific region among images acquired through the camera of the electronic device. In addition, the selection unit 215c may select data necessary for inference among input data acquired through the input device or input data pre-processed by the pre-processing unit.

In addition, the AI processor 215 may further include a model evaluation unit 215d to improve the analysis results of the neural network model. The model evaluation unit 215d may input evaluation data into the neural network model, and when the analysis result output from the evaluation data does not satisfy a predetermined criterion, may cause the model learning unit to learn again. In this case, the evaluation data may be preset data for evaluating the learning model 221. For example, among the analysis results of the learned neural network model for the evaluation data, when the number or ratio of evaluation data whose analysis results are not accurate exceeds a preset threshold, the model evaluation unit 215d may evaluate that a predetermined criterion are not satisfied.

The communication module 270 may transmit the AI processing result by the AI processor 215 to an external electronic device.

As described above, in FIG. 5, an example in which an AI process is implemented in the cloud environment due to computing operation, storage, and power constraints has been described, however, the present disclosure is not limited thereto, and the AI processor 215 may be implemented by being included in a client device. FIG. 6 is an example in which AI processing is implemented in the client device, and is the same as that shown in FIG. 5 except that the AI processor 215 is included in the client device.

FIG. 6 illustrates a schematic block diagram of an AI device according to another embodiment of the present disclosure.

The function of each configuration shown in FIG. 6 may refer to FIG. 5. However, since the AI processor is included in a client device 100, it may not be necessary to communicate with the server (200 in FIG. 5) in performing a process such as data classification/recognition, etc., accordingly, an immediate or real-time data classification/recognition operation is possible. In addition, since it is not necessary to transmit personal information of the user to the server (200 in FIG. 5), it is possible to classify/recognize data for the purpose without leaking the personal information.

On the other hand, each of the components shown in FIGS. 5 and 6 shows functional elements divided functionally, and at least one component may be implemented in a form (e.g. AI module) that is integrated with each other in a real physical environment. It goes without saying that components not disclosed may be included or omitted in addition to the plurality of components shown in FIGS. 5 and 6.

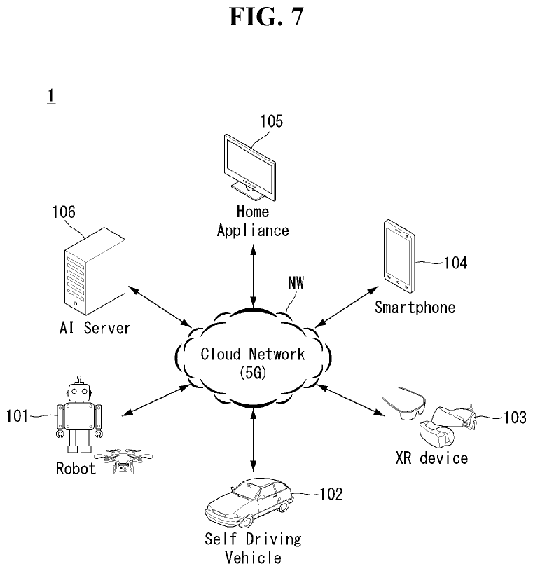

FIG. 7 is a conceptual diagram illustrating an embodiment of an AI device.

Referring to FIG. 7, in an AI system 1, at least one of an AI server 106, a robot 101, a self-driving vehicle 102, an XR device 103, a smartphone 104, or a home appliance 105 are connected to a cloud network NW. Here, the robot 101, the self-driving vehicle 102, the XR device 103, the smartphone 104, or the home appliance 105 applied with the AI technology may be referred to as the AI devices 101 to 105.

The cloud network NW may mean a network that forms a part of a cloud computing infrastructure or exists in the cloud computing infrastructure. Here, the cloud network NW may be configured using the 3G network, the 4G or the Long Term Evolution (LTE) network, or the 5G network.

That is, each of the devices 101 to 106 constituting the AI system 1 may be connected to each other through the cloud network NW. In particular, each of the devices 101 to 106 may communicate with each other through a base station, but may communicate directly with each other without going through the base station.

The AI server 106 may include a server performing AI processing and a server performing operations on big data.

The AI server 106 may be connected to at least one of the robots 101, the self-driving vehicle 102, the XR device 103, the smartphone 104, or the home appliance 105, which are AI devices constituting the AI system, through the cloud network NW, and may assist at least some of the AI processing of the connected AI devices 101 to 105.

At this time, the AI server 106 may learn the artificial neural network according to the machine learning algorithm on behalf of the AI devices 101 to 105, and directly store the learning model or transmit it to the AI devices 101 to 105.

At this time, the AI server 106 may receive input data from the AI devices 101 to 105, infer a result value for the received input data using the learning model, generate a response or a control command based on the inferred result value and transmit it to the AI devices 101 to 105.

Alternatively, the AI devices 101 to 105 may infer the result value for the input data directly using the learning model, and generate a response or a control command based on the inferred result value.

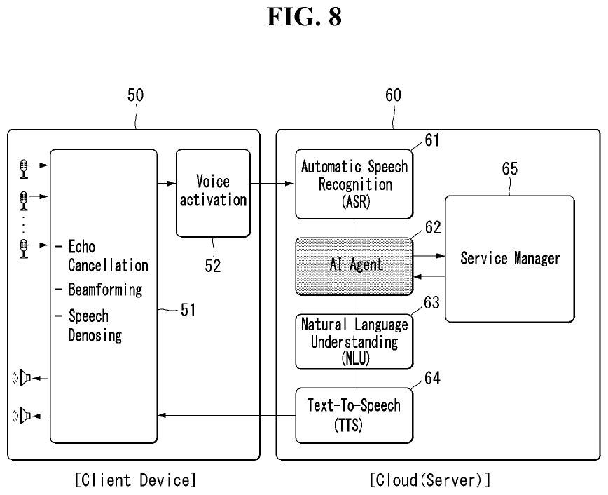

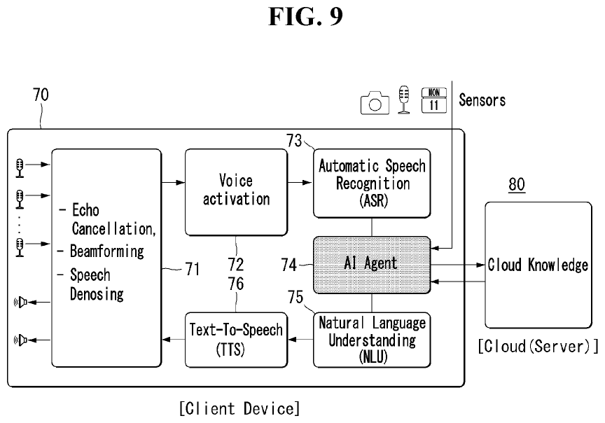

Hereinafter, a speech processing process performed in the device environment and/or the cloud environment or the server environment will be described with reference to FIGS. 8 and 9. FIG. 8 illustrates an example in which the input of speech may be performed in the device 50, but the process of synthesizing the speech by processing the input speech, that is, the overall operation of the speech processing is performed in the cloud environment 60. On the other hand, FIG. 9 illustrates an example of on-device processing in which the overall operation of the speech processing to synthesize the speech by processing the input speech described above is performed in the device 70.

In FIGS. 8 and 9, the device environment 50, 70 may be referred to as a client device, and the cloud environment 60, 80 may be referred to as a server.

FIG. 8 illustrates an exemplary block diagram of a speech processing apparatus in a speech processing system according to an embodiment of the present disclosure.

In an end-to-end speech UI environment, various components are required to process speech events. The sequence for processing the speech event performs speech signal acquisition and playback, speech pre-processing, voice activation, speech recognition, natural language processing and finally, a speech synthesis process in which the device responds to the user.

A client device 50 may include an input module. The input module may receive user input from a user. For example, the input module may receive the user input from a connected external device (e.g. keyboard, headset). In addition, for example, the input module may include a touch screen. In addition, for example, the input module may include a hardware key located on a user terminal.

According to an embodiment, the input module may include at least one microphone capable of receiving a user's speech as a voice signal. The input module may include a speech input system, and may receive a user's speech as a voice signal through the speech input system. The at least one microphone may generate an input signal for audio input, thereby determining a digital input signal for a user's speech. According to an embodiment, a plurality of microphones may be implemented as an array. The array may be arranged in a geometric pattern, for example, a linear geometry, a circular geometry, or any other configuration. For example, for a given point, the array of four sensors may be arranged in a circular pattern separated by 90 degrees to receive sound from four directions. In some implementations, the microphone may include spatially different arrays of sensors in data communication, including a networked array of sensors. The microphone may include omnidirectional, directional (e.g. shotgun microphone), and the like.

The client device 50 may include a pre-processing module 51 capable of pre-processing user input (voice signals) received through the input module (e.g. microphone).

The pre-processing module 51 may remove an echo included in a user voice signal input through the microphone by including an adaptive echo canceller (AEC) function. The pre-processing module 51 may remove background noise included in the user input by including a noise suppression (NS) function. The pre-processing module 51 may detect an end point of a user's voice and find a part where the user's voice is present by including an end-point detect (EPD) function. In addition, the pre-processing module 51 may adjust a volume of the user input to be suitable for recognizing and processing the user input by including an automatic gain control (AGC) function.

The client device 50 may include a voice activation module 52. The voice activation module 52 may recognize a wake up command that recognizes a user's call. The voice activation module 52 may detect a predetermined keyword (e.g. Hi LG) from the user input that has undergone a pre-processing process. The voice activation module 52 may exist in a standby state to perform an always-on keyword detection function.

The client device 50 may transmit a user voice input to a cloud server. Automatic speech recognition (ASR) and natural language understanding (NLU) operations, which are core components for processing user voice, are traditionally executed in the cloud due to computing, storage, and power constraints. The cloud may include a cloud device 60 that processes user input transmitted from a client. The cloud device 60 may exist in the form of a server.

The cloud device 60 may include an automatic speech recognition (ASR) module 61, an artificial intelligent agent 62, a natural language understanding (NLU) module 63, a text-to-speech (TTS) module 64, and a service manager 65.

The ASR module 61 may convert the user voice input received from the client device 50 into text data.

The ASR module 61 includes a front-end speech pre-processor. The front-end speech pre-processor extracts representative features from speech input. For example, the front-end speech pre-processor performs Fourier transformation of the speech input to extract spectral features that characterize the speech input as a sequence of representative multidimensional vectors. In addition, the ASR module 61 may include one or more speech recognition models (e.g. acoustic models and/or language models) and implement one or more speech recognition engines. Examples of the speech recognition models include hidden Markov models, Gaussian-Mixture Models, deep neural network models, n-gram language models, and other statistical models. Examples of the speech recognition engines include dynamic time distortion-based engines and weighted finite state transducer (WFST)-based engines. The one or more speech recognition models and the one or more speech recognition engines may be used to process the extracted representative features of the front-end speech pre-processor to generate intermediate recognition results (e.g. phonemes, phoneme strings, and sub-words), and ultimately text recognition results (e.g. words, word strings, or a sequence of tokens).

When the ASR module 61 generates recognition results including text strings (e.g. words, or a sequence of words, or a sequence of tokens), the recognition results are transmitted to a natural language processing module 732 for intention inference. In some examples, the ASR module 61 generates multiple candidate text representations of the speech input. Each candidate text representation is a sequence of words or tokens corresponding to the speech input.

The NLU module 63 may grasp user intention by performing syntactic analysis or semantic analysis. The syntactic analysis may divide syntactic units (e.g. words, phrases, morphemes, etc.) and determine what syntactic elements the divided units have. The semantic analysis may be performed using semantic matching, rule matching, or formula matching, etc. Accordingly, the NUL module 63 may acquire a domain, an intention, or a parameter necessary for expressing the intention by a user input.

The NLU module 63 may determine a user's intention and parameters using a mapping rule divided into domains, intentions, and parameters required to grasp the intentions. For example, one domain (e.g. an alarm) may include a plurality of intentions (e.g., alarm set, alarm off), and one intention may include a plurality of parameters (e.g. time, number of repetitions, alarm sound, etc.). A plurality of rules may include, for example, one or more essential element parameters. The matching rule may be stored in a natural language understanding database.

The NLU module 63 grasps the meaning of words extracted from user input by using linguistic features (for example, syntactic elements) such as morphemes and phrases, and determines the user's intention by matching the meaning of the grasped word to a domain and an intention. For example, the NLU module 63 may determine the user intention by calculating how many words extracted from the user input are included in each domain and intention. According to an embodiment, the NLU module 63 may determine a parameter of the user input using words that were the basis for grasping the intention. According to an embodiment, the NLU module 63 may determine the user's intention using the natural language recognition database in which linguistic features for grasping the intention of the user input are stored. In addition, according to an embodiment, the NLU module 63 may determine the user's intention using a personal language model (PLM). For example, the NLU module 63 may determine the user's intention using personalized information (e.g. contact list, music list, schedule information, social network information, etc.). The personal language model may be stored, for example, in the natural language recognition database. According to an embodiment, the ASR module 61 as well as the NLU module 63 may recognize the user's voice by referring to the personal language model stored in the natural language recognition database.

The NLU module 63 may further include a natural language generation module (not shown). The natural language generation module may change designated information into the form of text. The information changed into the text form may be in the form of natural language speech. The designated information may include, for example, information about additional input, information guiding completion of an operation corresponding to the user input, or information guiding an additional input of the user, etc. The Information changed into the text form may be transmitted to the client device and displayed on a display, or transmitted to a TTS module to be changed to a voice form.

A speech synthesis module (TTS module 64) may change text-type information into voice-type information. The TTS module 64 may receive the text-type information from the natural language generation module of the NLU module 63, and change the text-type information into the voice-type information and transmit it to the client device 50. The client device 50 may output the voice-type information through the speaker.

The speech synthesis module 64 synthesizes speech output based on a provided text. For example, results generated by the automatic speech recognition (ASR) module 61 are in the form of a text string. The speech synthesis module 64 converts the text string into audible speech output. The speech synthesis module 64 uses any suitable speech synthesis technique to generate speech output from texts, which includes concatenative synthesis, unit selection synthesis, diphone synthesis, domain-specific synthesis, formant synthesis, articulatory synthesis, hidden Markov model (HMM)-based synthesis, and sinewave synthesis, but is not limited thereto.

In some examples, the speech synthesis module 64 is configured to synthesize individual words based on the phoneme string corresponding to the words. For example, the phoneme string is associated with a word in the generated text string. The phoneme string is stored in metadata associated with words. The speech synthesis module 64 is configured to directly process the phoneme string in the metadata to synthesize speech-type words.

Since the cloud environments usually have more processing power or resources than the client devices, it is possible to acquire a speech output of higher quality than actual in client-side synthesis. However, the present disclosure is not limited to this, and it goes without saying that a speech synthesis process may be performed on the client side (see FIG. 9).

On the other hand, according to an embodiment of the present disclosure, the cloud environment may further include an artificial intelligence (AI) agent 62. The AI agent 62 may be designed to perform at least some of the functions performed by the ASR module 61, the NLU module 63, and/or the TTS module 64 described above. In addition, the AI agent module 62 may contribute to perform an independent function of each of the ASR module 61, the NLU module 63, and/or the TTS module 64.

The AI agent module 62 may perform the functions described above through deep learning. The deep learning represents data in a form (for example, in a case of an image, pixel information is expressed as a column vector) that the computer can understand when there is any data, and many studies (how to make better representation techniques and how to build a model to learn them) are being conducted to apply this to learning. As a result of these efforts, various deep learning techniques such as deep neural networks (DNN), convolutional deep neural networks (CNN), recurrent Boltzmann machine (RNN), restricted Boltzmann machine (RBM), deep belief networks (DBN), deep Q-network may be applied to fields such as computer vision, speech recognition, natural language processing, and voice/signal processing.

Currently, all major commercial speech recognition systems (MS Cortana, Skype translator, Google Now, Apple Siri, etc.) are based on deep learning techniques.

In particular, the AI agent module 62 may perform various natural language processing processes including machine translation, emotion analysis, information retrieval using deep artificial neural network structure in the field of natural language processing.

On the other hand, the cloud environment may include a service manager 65 capable of collecting various personalized information and supporting the function of the AI agent 62. The personalized information acquired through the service manager may include at least one data (calendar application, messaging service, music application use, etc.) that the client device 50 uses through the cloud environment, at least one sensing data (camera, microphone, temperature, humidity, gyro sensor, C-V2X, pulse, ambient light, iris scan, etc.) that the client device 50 and/or cloud 60 collect, and off device data not directly related to the client device 50. For example, the personalized information may include maps, SMS, news, music, stock, weather, Wikipedia information.

The AI agent 62 is represented in separate blocks to be distinguished from the ASR module 61, the NLU module 63, and the TTS module 64 for convenience of description, but the AI agent 62 may perform functions of at least a part or all of the modules 61, 62, and 64.

In the above, FIG. 8 has described an example in which the AI agent 62 is implemented in the cloud environment due to computing operation, storage, and power constraints, but the present disclosure is not limited thereto.

For example, FIG. 9 is the same as that shown in FIG. 8, except that the AI agent is included in the client device.

FIG. 9 illustrates an exemplary block diagram of a speech processing apparatus in a speech processing system according to another embodiment of the present disclosure. A client device 70 and a cloud environment 80 illustrated in FIG. 9 may correspond only with differences in some configurations and functions of the client device 50 and the cloud environment 60 mentioned in FIG. 8. Accordingly, FIG. 8 may be referred to a specific function of the corresponding block.

Referring to FIG. 9, the client device 70 may include a pre-processing module 51, a voice activation module 72, an ASR module 73, an AI agent 74, an NLU module 75, and a TTS module 76. In addition, the client device 70 may include an input module (at least one microphone) and at least one output module.

In addition, the cloud environment may include cloud knowledge 80 that stores personalized information in the form of knowledge.

The function of each module illustrated in FIG. 9 may refer to FIG. 8. However, since the ASR module 73, the NLU module 75, and the TTS module 76 are included in the client device 70, communication with the cloud may not be necessary for speech processing such as speech recognition and speech synthesis. Accordingly, an instant and real-time speech processing operation is possible.

Each module illustrated in FIGS. 8 and 9 is only an example for explaining a speech processing process, and may have more or fewer modules than the modules illustrated in FIGS. 8 and 9. It should also be noted that two or more modules may be combined or have different modules or different arrangements of modules. The various modules shown in FIGS. 8 and 9 may be implemented with software instructions, firmware, or a combination thereof for processing by one or more signal processing and/or on-demand integrated circuits, hardware, or one or more processors.

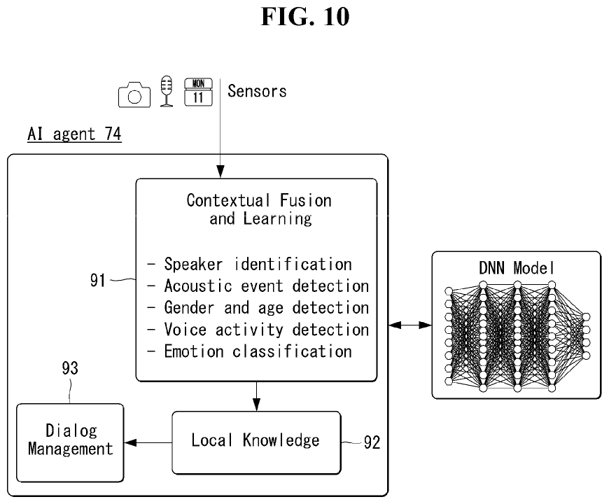

FIG. 10 illustrates an exemplary block diagram of an artificial intelligent agent according to an embodiment of the present disclosure.

Referring to FIG. 10, the AI agent 74 may support interactive operation with a user in addition to performing ASR operation, NLU operation, and TTS operation in the speech processing described through FIGS. X1 and X2. Alternatively, the AI agent 74 may contribute to the NLU module 63 that performs an operation of clarifying, supplementing, or additionally defining information included in text expressions received from the ASR module 61 using context information.

Here, the context information may include client device user preferences, hardware and/or software states of the client device, various sensor information collected before, during, or immediately after user input, previous interactions (e.g. conversations) between the AI agent and the user. It goes without saying that the context information in the present disclosure is dynamic and varies depending on time, location, content of the conversation and other factors.

The AI agent 74 may further include a contextual fusion and learning module 91, a local knowledge 92, and a dialog management 93.

The contextual fusion and learning module 91 may learn a user's intention based on at least one data. The at least one data may include at least one sensing data acquired in a client device or a cloud environment. In addition, the at least one data may include speaker identification, acoustic event detection, speaker's personal information (gender and age detection), voice activity detection (VAD), emotion classification.

The speaker identification may mean specifying a person who speaks in a conversation group registered by voice. The speaker identification may include a process of identifying a previously registered speaker or registering a new speaker. The acoustic event detection may recognize the type of sound and the place where the sound is generated by recognizing the sound itself beyond the speech recognition technology. The voice activity detection (VAD) is a speech processing technique in which the presence or absence of human speech (voice) is detected in the audio signal, which may include music, noise or other sounds. According to an example, the AI agent 74 may confirm whether speech is present from the input audio signal. According to an example, the AI agent 74 may distinguish speech data from non-speech data using the deep neural network (DNN) model. In addition, the AI agent 74 may perform an emotion classification operation on speech data using the deep neural network (DNN) model. According to the emotion classification operation, the speech data may be classified into anger, boredom, fear, happiness, and sadness.

The contextual fusion and learning module 91 may include the DNN model to perform the above-described operations, and confirm the intention of user input based on the DNN model and sensing information collected in the client device or cloud environment.

The at least one data is merely exemplary, and any data that may be referred to confirm a user's intention in a speech processing process may be included. The at least one data may be acquired through the DNN model described above.

The AI agent 74 may include the local knowledge 92. The local knowledge 92 may include user data. The user data may include a user preference, a user address, a user's initial setting language, and a user's contact list. According to an example, the AI agent 74 may further define the user's intention by supplementing information included in the user's voice input by using the user's specific information. For example, in response to a user's requesting “Invite my friends to my birthday party”, the AI agent 74 may utilize the local knowledge 92 without asking the user to provide more clear information to determine who the “friends” are and when and where the “birthday party” is held.

The AI agent 74 may further include the dialog management 93. The dialog management 93 may be called a dialog manager. The dialog manager 93 is a basic component of the speech recognition system, and may manage essential information to generate an answer to the user intention analyzed by the NLP. In addition, the dialog manager 93 may detect a barge-in event that receives a user's voice input while the synthesized voice is output through the speaker in the TTS system.

The AI agent 74 may provide a dialog interface to enable voice conversation with a user. The dialog interface may mean a process of outputting a response to a user's voice input through a display or a speaker. Here, a final result output through the dialog interface may be based on the above-described ASR operation, NLU operation, and TTS operation.

The above-described AI device, AI server, or AI system may be applied in combination with the methods proposed in the present disclosure, which will be described later, or supplemented to specify or clarify the technical characteristics of the methods proposed in the present disclosure. In addition, in the following description, the AI device or the AI server may be referred to as a “speech processing device” that performs a speech processing function. In addition, ‘model’ may be used interchangeably with ‘module’. The natural language processing method according to various embodiments of the present disclosure is described based on processing in the AI server, but the same function and operation may be performed in the AI device.

In the following description, a method for generating a phoneme-based learning model and an inference process using a phoneme-based learning model will be described. In conventional NE recognition, mismatching may occur due to ‘different accents’ or ‘foreigner's pronunciation’ for the same word.

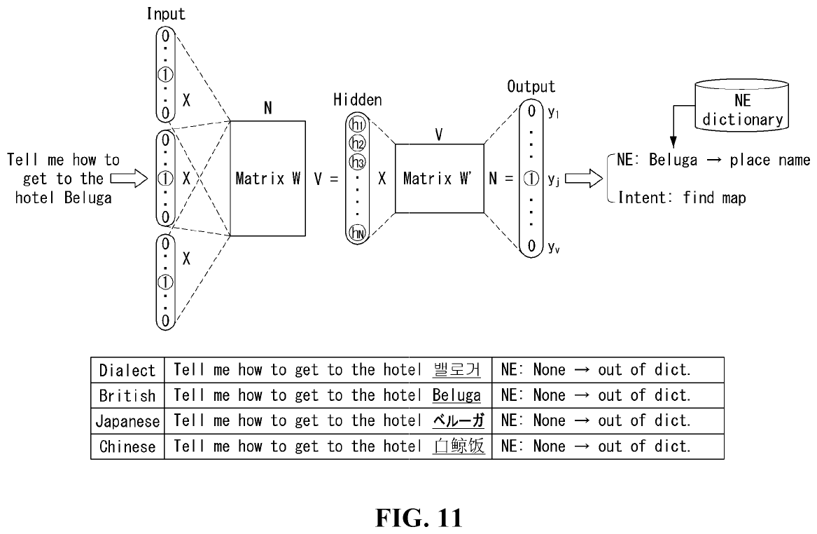

FIG. 11 is a view for explaining a speech recognition method by a conventional speech.

Referring to FIG. 11, the speech recognition system may receive various voice inputs with respect to a sentence “Tell me how to get to the hotel Beluga” in the standard language. More specifically, the speech recognition system may receive input including a dialect of another region, input of a British accent, input of a Japanese accent, or input of a Chinese accent with respect to the sentence composed of the standard language. For example, the input including the dialect of another region may be, “Tell me how to get to the hotel [symbol] ”, the input of the British accent may be, “Tell me how to get to the hotel Beluga”, the input of the Japanese accent may be, “Tell me how to get to the hotel [symbol] ”, and the input of the Chinese accent may be “how to get to the hotel [symbol] ”. For reference, [symbol] may be called Berūga, and [symbol] may be called Báijīng fàn. Here, “Beluga” is a name of a specific region and is presumed to be a named entity not stored in an NE dictionary.

As such, the Beluga representing the name of a place may be expressed in different accents according to various dialects and/or pronunciations based on the languages of different countries. The NE dictionary is difficult to store all named entity corresponding to various pronunciations for a specific word, as a result, the speech recognition system has a problem in that, as shown in the table in FIG. 11, it is impossible to output an appropriate named entity recognition result in response to input of an unregistered named entity among various pronunciations for “Beluga”.

On the other hand, the input including the dialect of another region, the input of the British accent, the input of the Japanese accent, or the input of the Chinese accent with respect to the sentence composed of the standard language is an example for explaining the technical features of some embodiments, and the present disclosure is not limited to apply to the dialect and/or accent of the above-described examples.

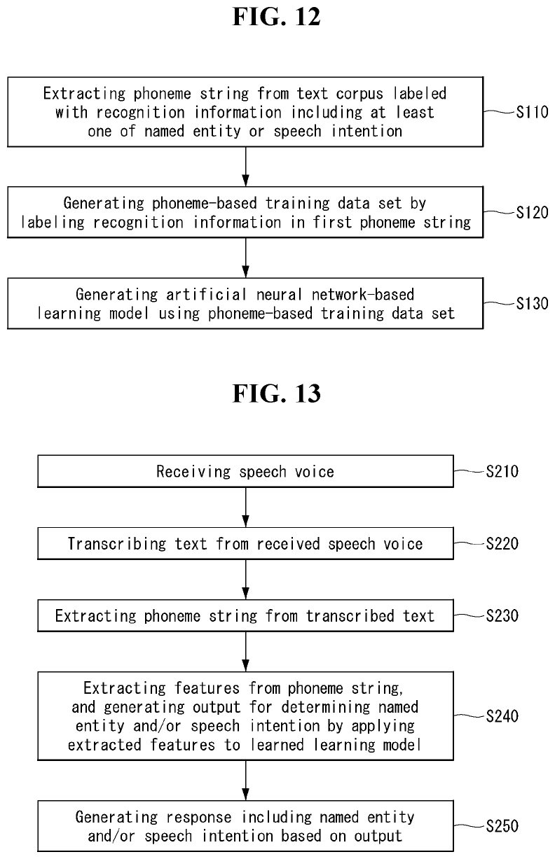

In order to overcome these problems and/or necessities, in FIG. 12, a method for generating a learning model based on a phoneme will be described. The AI processing described in the following disclosure may be performed in the AI server or the AI device described above with reference to FIGS. 4 to 6, and the processor refers to an AI server or a processor of the AI device.

FIG. 12 is a schematic flowchart of a method for generating a phoneme-based learning model according to some embodiments of the present disclosure.

Referring to FIG. 12, the processors 110 and 210 may extract a phoneme string from a text corpus labeled with recognition information including at least one of a named entity or a speech intention (S110).

The phoneme string is a phoneme string corresponding to one named entity (NE) extracted from a grapheme-based text corpus including texts of different accents or languages for the one NE

In an embodiment of the present disclosure, the text corpus may include at least two languages. For example, the language includes various languages such as Korean, English, Japanese, Chinese, Spanish, German, French, Hindi, or Italian, but it is not limited thereto. In another embodiment of the present disclosure, the text corpus may include a dialect of at least one region. For example, in the case of Hangul (Korean), it may include a dialect of Gyeongsangnam-do, a dialect of Gyeongsangbuk-do, a dialect of Jeollanam-do, a dialect of Jeollabuk-do, a dialect of Gangwon-do or a dialect of Jeju-do, but it is not limited thereto. In another embodiment of the present disclosure, the text corpus may include at least two languages and at least one dialect according to a region of each language. For example, the text corpus may include dialects for each of a variety of languages.

On the other hand, with respect to a method of extracting a phoneme string in the natural language processing method according to an embodiment of the present disclosure, the processors 110 and 210 may generate phonemes corresponding to each syllable of at least one paragraph, sentence, or word included in the text corpus using the text corpus.

The phoneme string generating method may include (i) a method of generating a phoneme string based on a phonological change rule, (ii) a method of generating a statistical phoneme string using a phoneme string dictionary, (iii) a method of generating a statistical phoneme string using a phoneme transcribed learning database. The method of generating the phoneme string based on the phonological change rule may include a method of automatically generating a phoneme string for an input test according to a phonological rule. The method of generating the statistical phoneme string using the phoneme string dictionary is a method of constructing a phoneme string dictionary by phoneme transcription of various corpuses, a method of generating a phoneme conversion model by learning the phoneme string dictionary through various statistical learning methods, and a method of generating a phoneme string for an input test using the generated phoneme conversion model. It can solve the difficulty of handling of exceptional phonemes and determining the order of rules. The method of generating the statistical phoneme string using the phoneme transcribed learning database is a method of performing a phoneme string conversion by performing statistical training based on a speaker's speech database used in an actual synthesis system. It has the advantage of being able to perform variation tone model or speaker-dependent phoneme conversion.

In one example of the method of generating the phoneme string, the processors 110 and 210 may generate an output by extracting a feature from the text corpus, and applying the extracted feature to a first model for generating a phoneme. The processors 110 and 210 may generate a phoneme corresponding to each syllable included in the text corpus based on the output of the first model. However, it is not limited to this. Here, the first model may be a G2P model capable of supporting grapheme to phoneme (G2P) conversion. The processors 110 and 210 may take a plain text string as an input using the G2P model and automatically generate speech transcription.

Here, when a plurality of texts having different accents for the same entity exist among texts included in the text corpus, the first model may be an artificial neural network-based learning model trained to generate an output representing the same phoneme string when the plurality of texts are applied to the first model. At this time, the output may be expressed as a vector column or matrix.

The processors 110 and 210 may generate a phoneme-based training data set by labeling recognition information in the first phoneme string (S120).

More specifically, the processors 110 and 210 may generate an output by extracting a feature from the first phoneme string, and applying the extracted feature to a second model for labeling the recognition information. The processors 110 and 210 may tag at least one of the NE or the speech intention in the first phoneme string based on the output. In this case, the feature may be expressed as a vector representing at least one phoneme included in the first phoneme string, and the vector may include a context. In various embodiments of the present disclosure, the processors 110 and 210 may perform labeling by tagging the named entity information tagged to at least one syllable included in the text corpus in the phoneme corresponding to the syllable.

For example, the text “Beluga” may be “BEL LU GA” when expressed as phonemes. Here, “Beluga” may be tagged with the named entity information, and specifically, the named entity information may be tagged as “ [symbol] B-place”, “ [symbol] I-place”, and “ [symbol] I-place”. At this time, the processors 110 and 210 may tag the same named entity information in the phoneme to correspond to each syllable. Specifically, the processors 110 and 210 may tag as “BEL B-place”, “LU I-place”, or “GA I-place”. On the other hand, in the above-described example, it has been described based on a commonly used representation of begion-inside-outside (BIO), but is not limited thereto.

For another example, it may be “HO TEL BEL LU GA GA NEUN GIL AL REY JEO” when expressed in phonemes with the text “ [symbol] [symbol] ”. Here, “Find MAP” may be tagged as the speech intention in “ [symbol] [symbol] ”. At this time, the processors 110 and 210 may tag “FIND MAP”, which is the speech intention to “HO TEL BEL LU GA GA NEUN GIL AL REY JEO”, which is the phoneme string corresponding to “ [symbol] [symbol] ” using the second model.

In various embodiments of the present disclosure, the second model may include a first sub-model for tagging the named entity and a second sub-model for tagging the speech intention. At this time, the first and second sub-models may be functionally divided or merged to form the second model.

As such, the processors 110 and 210 may generate a training data set for generating or training a phoneme-based learning model by labeling recognition information in the phoneme string generated from the text corpus using the second model.

The processors 110 and 210 may generate an artificial neural network-based learning model using the phoneme-based training data set (S130).

At this time, the processors 110 and 210 may generate an artificial neural network-based learning model in a supervised learning method. The artificial neural network may include an input layer, an output layer and at least one hidden layer, and the input layer, the output layer, and the at least one hidden layer may include at least one node (or neuron). In addition, some of the at least one node may have different weights to generate targeted output. The artificial neural network which is the basis of the artificial neural network-based learning model applied to various embodiments of the present disclosure may be either a convolutional neural network or a recurrent neural network, but is not limited thereto.

On the other hand, the artificial neural network-based learning model applied to various embodiments of the present disclosure may include an acoustic model (AM) for predicting a confidence score of a named entity, or a language model (LM) for predicting a confidence score of a speech intention.

The language model is a model for allocating probability to a word sequence or sentence, and may be used to predict a next word in response to a previous word. The language model may include a statistical language model (SLM) or an artificial neural network-based language model, but is not limited thereto. The acoustic model may include a hidden Markov model (HMM). The HMM may model the system as the Markov process using the hidden state. Each HMM state may be represented as a multivariate Gaussian distribution that characterizes the statistical behavior of the state. On the other hand, the acoustic model has been described an implementation by the HMM-based model, but is not limited thereto.

As described above, the text corpus used in some embodiments of the present disclosure may include texts including at least two languages or at least one dialect with respect to texts having the same named entity and/or speech intention. The text corpus used in some embodiments of the present disclosure may be a corpus prepared in advance for use in training a syllable-based learning model, and since the method for generating a phoneme-based learning model according to an embodiment of the present disclosure may use a corpus for training a syllable-based learning model in the same way, there is no need to collect data for the generation of the corpus separately. On the other hand, it is not always limited to not collecting data, and in some embodiments, additional data may be collected.

In addition, in some embodiments of the present disclosure, the processors 110 and 210 may derive an appropriate expected result even if a word is not learned based on a syllable or is not registered in a syllable-based named entity dictionary by outputting one phoneme string even if the various texts have different accents for various texts.

FIG. 13 is a schematic flowchart of an inference process using a learned phoneme-based learning model.

Referring to FIG. 13, a speech processing device may receive a user's speech voice through a microphone or receive the speech voice through a communication module from another communicable device (S210).

Here, the speech processing device that receives the speech voice may be any one of a device that perform AI processing related to speech processing, or a device that can communicate with an AI server performing the AI processing. On the other hand, the device may be any one of a server, a TV, a refrigerator, an oven, a clothing styler, a robotic vacuum, a drone, an air conditioner, an air cleaner, a PC, a speaker, a home CCTV, a light, a washing machine, and a smart plug, but is not limited thereto.

The processors 110 and 210 may transcribe a text from the received speech voice (S220).

The processors 110 and 210 may transcribe the speech voice through automatic transcription or manual transcription. The processors 110 and 210 may map audio utterance to a textual representation using an automatic speech recognition (ASR) method.

The processors 110 and 210 may extract a phoneme string from the transcribed text (S230).

Extracting of the phoneme string may be extracted by being performed by the various phoneme string generating methods described above in S110 of FIG. 12 or using the G2P model. At this time, the G2P model used in FIG. 13 may be the same model as the model used to generate the learning model described above in FIG. 12.

The processors 110 and 210 may extract features from the phoneme string, and generate an output for determining the named entity and/or the speech intention by applying the extracted features to the learned learning model (S240).

Here, the feature may be configured as a sentence vector that represents entire contents of the phoneme string or contents of each word constituting the phoneme string, but is not limited thereto.

The processors 110 and 210 may generate a response including the named entity and/or the speech intention based on the output (S250).

The processors 110 and 210 may determine the named entity and/or the speech intention corresponding to an output exceeding a preset threshold by analyzing the output. At this time, when there are a plurality of named entities and/or the speech intentions corresponding to outputs exceeding the preset threshold, the processors 110 and 210 may select an inference result based on a user's selection for the plurality of named entities and/or speech intentions or select an the named entity and/or the speech intention corresponding to a highest value among the plurality of the outputs as the inference result.

As described above, the natural language processing method according to an embodiment of the present disclosure may save time or cost investment for generating an additional model by using the learning model for generating the phoneme string used for generating the learning model in the inference step using the previously generated learning model.

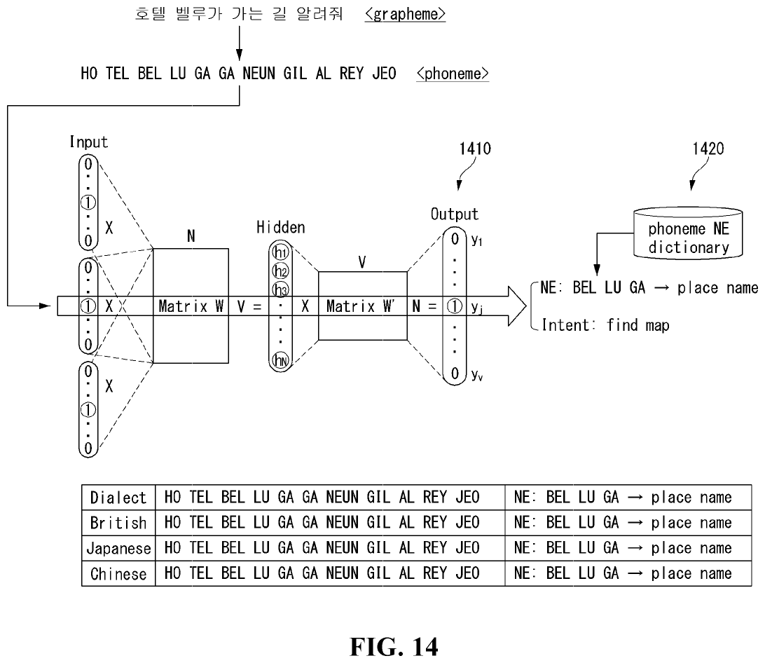

FIG. 14 is a view showing an example of implementation of a natural language processing method according to an embodiment of the present disclosure.

Referring to FIG. 14, the processors 110 and 210 may extract a phoneme string from a text stored in a pre-stored text corpus. The text corpus may store texts composed of various accents and/or languages. For example, the processors 110 and 210 may generate a text composed of phonemes “HO TEL BEL LU GA GA NEUN GIL AL REY JEO” from a text composed of graphemes ‘ [symbol] [symbol] ’ stored in the text corpus using the G2P model.

At this time, the named entity ‘ [symbol] ’ may be variously expressed according to various languages and/or accents. For example, the ‘ [symbol] ’ may be expressed as ‘ [symbol] ’ in a dialect, ‘Beluga’ in a British accent, ‘ [symbol] ’ in Japanese, and [symbol] in Chinese. The text matched to a voice input based on various languages and/or accents may be words that are not stored in a preset named entity dictionary (the named entity dictionary of FIG. 11).

In the natural language processing method according to an embodiment of the present disclosure, the processors 110 and 210 may convert expressions according to various languages and/or accents described above into the same phonemes using the G2P model. Here, the G2P model may be an artificial neural network-based learning model trained to generate an output representing the same phoneme for a plurality of words having the same named entity in meaning, including the various languages or accents included in the text corpus using the text corpus that includes the various languages or accents. For example, the processors 110 and 210 may generate outputs representing phoneme strings (or pronunciation strings) called ‘BEL LU GA’ by receiving ‘ [symbol] ’, ‘Beluga’, ‘ [symbol] ’ and ‘ [symbol] ’ as inputs using the pre-trained G2P model.

The processors 110 and 210 may generate a phoneme-based learning model 1410 using the text composed of the phonemes generated as described above. At this time, the trained learning model 1410 may determine or identify a speech intention for the input and/or a named entity included in the input. In the natural language processing method according to an embodiment of the present disclosure, the processors 110 and 210 may determine or identify the named entity included in the input of the learning model 1410 by comparing a preset phoneme-based named entity dictionary 1420 with the output of the pre-trained learning model 1410 through the phonemes. On the other hand, the phoneme-based named entity dictionary 1420 may be generated by receiving a named entity dictionary 1420 generated based on phonemes through a communication module from an external device, or by converting or extracting a plurality of named entity information included in the grapheme-based named entity dictionary (for example, the named entity dictionary of FIG. 11) preset in the speech processing device through the G2P processing inside the speech processing device into phoneme-based named entity information.

For reference, the phoneme-based learning model 1410 applied to an embodiment of the present disclosure may derive a robust inference result with respect to unknown NEs that have not been previously trained unlike the grapheme-based learning model described in FIG. 11. More specifically, FIG. 14 shows texts composed of phonemes for text inputs composed of graphemes of dialects, English, Japanese, and Chinese in the table. The G2P model applied to an embodiment of the present disclosure is not a model trained to transcribe phonemes corresponding to graphemes, but a model trained to output the same phoneme for various accents and/or languages, and has a differentiating effect from the conventional G2P model.

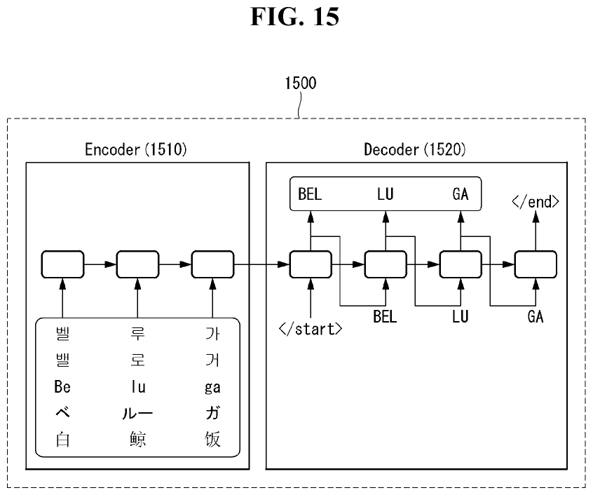

The G2P model applied to an embodiment of the present disclosure may be used to change or extract the graphemes of various accents and/or languages into the same phonemes as a sequence to sequence (seq2seq) model. A detailed description of the G2P model will be described in FIG. 15.

FIG. 15 is an exemplary diagram of a G2P model applied to an embodiment of the present disclosure.

Referring to FIG. 15, a G2P model 1500 may be implemented as a sequence to sequence (seq2seq) model. Here, the seq2seq model includes an encoder 1510 and a decoder 1520. The encoder 1510 may receive each word included in an input sentence in time series, and generate a sentence vector representing all words included in the sentence and the context of all the words. The encoder 1510 may transmit the generated sentence vector to the decoder 1520, and the decoder 1520 may receive the sentence vector representing all words included in the sentence and the context of all the words. The decoder 1520 may sequentially output the changed word according to the previously learned content by receiving the sentence vector. The seq2seq model is obvious to those skilled in the art of the natural language processing, and the above description will be omitted.

As described above, the G2P model 1500 applied to an embodiment of the present disclosure is an artificial neural network-based learning model that is pre-trained to output the same phoneme when receiving inputs of various languages and/or accents. The G2P model 1500 is a recurrent neural network (RNN)-based learning model, and the recurrent neural network may be composed of vanilla RNN, LSTM cells, or GRU cells, but is not limited thereto.

Referring back to FIG. 15, the processors 110 and 210 input ‘ [symbol] ’, ‘ [symbol] ’, ‘Beluga’, ‘ [symbol] ’ or ‘ [symbol] ’ in the encoder 1510 of the G2P model 1500. The processors 110 and 210 may transmit a sentence vector of ‘ [symbol] ’, ‘ [symbol] ’, ‘Beluga’, ‘ [symbol] ’ or ‘ [symbol] ’ generated by the encoder 1510 to the decoder 1520, and generate an output of the same phoneme through the decoder 1520. That is, the processors 110 and 210 may generate the output of ‘BEL LU GA’ for the inputs of ‘ [symbol] ’, ‘ [symbol] ’, ‘Beluga’, ‘ [symbol] ’ and ‘ [symbol] ’ using the G2P model 1500.

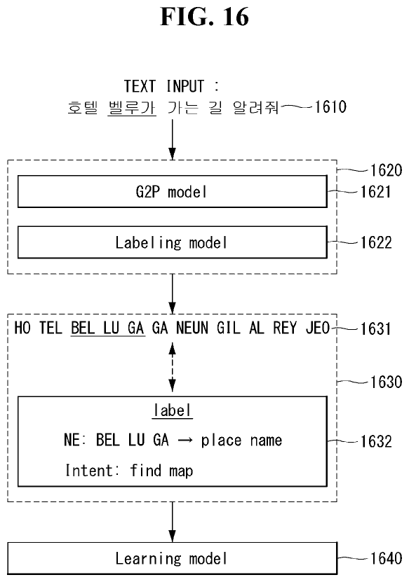

FIG. 16 is an example of implementation of a method for generating a phoneme-based learning model according to an embodiment of the present s disclosure.

Referring to FIG. 16, the processors 110 and 210 may generate phoneme-based training data 1630 from grapheme-based training data 1610 using a training data generation model 1620. As described above, a grapheme-based learning model 1640 may have a limitation in not responding to unidentified named entity in deriving classification or inference results, and the method for generating the learning model 1640 according to an embodiment of the present disclosure may generate the phoneme-based learning model 1640 using the conventional grapheme-based training data 1610.

The training data generation model 1620 may include a G2P model 1621 and a labeling model 1622. Here, the description of the G2P model 1621 has been described with reference to FIG. 15, and thus is omitted.

The labeling model 1622 is a model that performs a function of labeling information for supervised learning of the learning model 1640 to a text composed of phonemes generated from the output of the G2P model 1621. The labeling model 1622 may be implemented as the learning model 1640 based on the recurrent neural network.

The processors 110 and 210 may generate a sentence 1630 composed of phonemes corresponding to a sentence composed of graphemes input through the training data generation model 1620, and the named entity or speech intention may be tagged in the sentence composed of the phoneme to match the sentence 1610 input to the training data generation model 1620. For example, the processors 110 and 210 may generate a sentence composed of phonemes ‘HO TEL BEL LU GA GA NEUN GIL AL REY JEO’ from the sentence composed of graphemes ‘ [symbol] [symbol] ’ using the training data generation model 1620. In addition, ‘BEL LU GA’ may be labeled with the named entity such as ‘BEL B-place’, ‘LU I-place’, and ‘GA I-place’, respectively, and ‘HO TEL BEL LU GA GA NEUN GIL AL REY JEO’ may be labeled with the speech intention of ‘FIND MAP’.

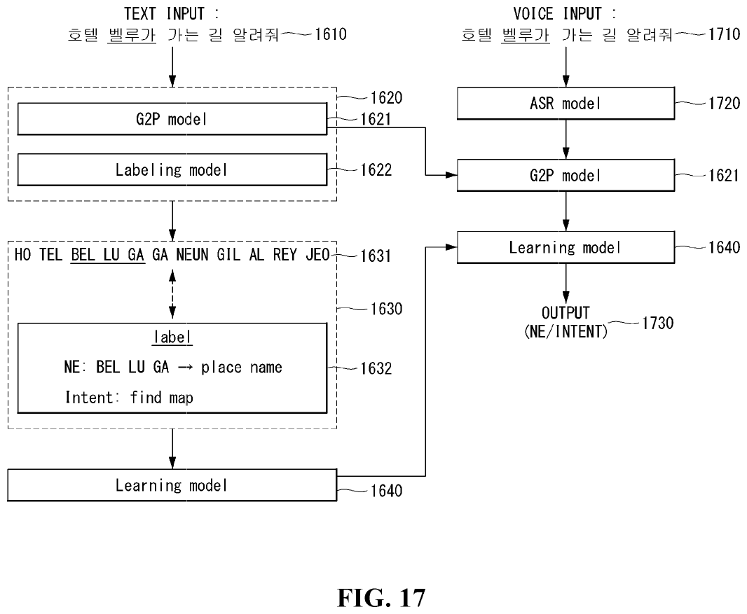

The processors 110 and 210 may generate an artificial neural network-based learning model 1640 using a plurality of sentences composed of phonemes labeled with the named entity or speech intention. The inference process using the generated learning model 1640 will be described later in FIG. 17.

FIG. 17 is an example of implementation of a natural language processing method using a phoneme-based learning model according to an embodiment of the present disclosure.

Referring to FIG. 17, the processors 110 and 210 may generate a response 1730 regarding a voice input 1710 of a speaker input using the learning model 1640, the ASR model 1720, and the G2P model 1621 generated by the above-described process in FIG. 16. On the other hand, the descriptions of the ASR model 1720 and the G2P model 1621 have been described in the previous disclosure, and thus will be omitted.

The processors 110 and 210 may transcribe a phoneme-based text for the a voice input 1710 of the speaker, and apply the transcribed phoneme-based text to the phoneme-based learning model 1640. The processors 110 and 210 may determine at least one of the named entity or the speech intention according to the output of the phoneme-based learning model 1640. The processors 110 and 210 may generate a response 1730 to the user's speech using at least one of the determined named entity or speech intention. The response 1730 to the user's speech may include response information according to the determined or identified named entity and speech intention.

The above-described present disclosure can be implemented as a computer-readable code on a medium on which a program is recorded. The computer readable medium includes all kinds of recording devices in which data that can be read by a computer system is stored. Examples of the computer readable medium may include a hard disk drive (HDD), a solid state disk (SSD), a silicon disk drive (SDD), a ROM, a RAM, a CD-ROM, a magnetic tape, a floppy disk, an optical data storage device, and the like, or be implemented in the form of a carrier wave (e.g., transmission over the internet). Accordingly, the above detailed description should not be construed in all aspects as limiting, and be considered illustrative. The scope of the present disclosure should be determined by rational interpretation of the appended claims, and all changes within the equivalent range of the present disclosure are included in the scope of the present disclosure.

What is claimed is:

1. A natural language processing (NLP) method, comprising:
extracting a first phoneme string corresponding to one named entity (NE) from a grapheme-based text corpus including texts of different accents or languages for the one NE;
generating a phoneme-based training data set by labeling at least one of the NE or speech intention in the first phoneme string; and
generating an artificial neural network-based learning model (LM) using the phoneme-based training data set.

2. The method of claim 1, wherein the text corpus includes at least two languages.

3. The method of claim 1, wherein the text corpus includes at least one dialect.

4. The method of claim 1, wherein the extracting the first phoneme string includes:
generating an output by extracting a first feature from the text corpus, and applying the first feature to a first model for generating a phoneme; and
generating a phoneme corresponding to each syllable included in the text corpus based on the output.

5. The method of claim 4, wherein when the texts of different accents or languages for the one NE exist among texts included in the text corpus,
the first model is an artificial neural network-based LM trained to generate an output representing the same phoneme string when the texts of different accents or languages are applied to the first model.

6. The method of claim 1, wherein the generating the phoneme-based training data set includes:
generating an output by extracting a second feature from the first phoneme string, and applying the second feature to a second model for labeling at least one of the NE or the speech intention; and
tagging at least one of the NE or the speech intention in the first phoneme string based on the output.

7. The method of claim 1, further comprising:
receiving a speech voice;
transcribing a text from the received speech voice;
extracting a second phoneme string from the transcribed text, and extracting a third feature from the second phoneme string; and
generating an output for determining the NE or the speech intention by applying the third feature to the LM.

8. The method of claim 7, further comprising:
generating a response including the NE or the speech intention based on the output.

9. The method of claim 1, wherein the LM includes an acoustic model for predicting a confidence score of the NE or a language model for predicting the speech intention.

10. A natural language processing apparatus, comprising:
a memory configured to store a grapheme-based text corpus including texts of different accents or languages for one named entity (NE); and
a processor configured to:
extract a first phoneme string corresponding to the one NE from the grapheme-based text corpus;
generate a phoneme-based training data set by labeling at least one of the NE or speech intention in the first phoneme string; and
generate an artificial neural network-based learning model (LM) using the phoneme-based training data set.

11. The apparatus of claim 10, wherein the text corpus includes at least two languages.

12. The apparatus of claim 10, wherein the text corpus includes at least one dialect.

13. The apparatus of claim 10, wherein the processor is configured to generate the first phoneme string by:
generating an output by extracting a first feature from the text corpus, and applying the first feature to a first model for generating a phoneme; and
generating a phoneme corresponding to each syllable included in the text corpus based on the output.

14. The apparatus of claim 13, wherein when the texts of different accents or languages for the one NE exist among texts included in the text corpus,
the first model is an artificial neural network-based LM trained to generate an output representing the same phoneme string when the texts of different accents or languages are applied to the first model.

15. The apparatus of claim 10, wherein the processor is configured to generate the phoneme-based training data set by:
generating an output by extracting a second feature from the first phoneme string, and applying the second feature to a second model for labeling at least one of the NE or the speech intention; and
tagging at least one of the NE or the speech intention in the first phoneme string based on the output.

16. A computer-readable recording medium on which a program for implementing the method according to claim 1 is recorded.
